(19) United States
(12) Patent Application Publication
(10) Pub. No.: US 2013/0257191 A1
(43) Pub. Date: Oct. 3, 2013

(54) DRIVE APPARATUS

(71) Applicant: DENSO CORPORATION, Kariya-city (JP)

(72) Inventors: Tatsuya ABE, Chiryu-city (JP); Hiroshi KATAI, Toyohashi-city (JP); Yuuji YAMASHITA, Toyohashi-city (JP)

(73) Assignee: DENSO CORPORATION, Kariya-city (JP)

(21) Appl. No.: 13/853,432

(22) Filed: Mar. 29, 2013

(30) Foreign Application Priority Data
Mar. 29, 2012 (JP) 2012-76695

(51) Int. Cl. H02K 9/00

(52) U.S. Cl. CPC H02K 9/00
USPC 310/52

(57) ABSTRACT

A drive apparatus includes a motor unit and an electronic control unit. The motor unit includes a first end frame, a second end frame, a stator, a rotor and a shaft. The control unit controls driving of the shaft. An outer wall surface of the stator is exposed between the first end frame and the second end frame. The stator is thus enabled to contact outside air directly so that heat radiation characteristic of the stator is improved.

### CROSS REFERENCE TO RELATED APPLICATION

This application is based on and incorporates herein by reference Japanese patent application No. 2012-76695 filed on Mar. 29, 2012.

### TECHNICAL FIELD

The present disclosure relates to a drive apparatus, which integrates therein a motor unit and an electronic control unit for controlling a motor.

### BACKGROUND

Some conventional drive apparatuses integrate therein a motor and an electronic circuit for controlling driving of the motor. According to a drive apparatus disclosed in JP 2011-10409A (US 2010/0327678 A1), for example, a motor unit and an electronic circuit are juxtaposed in an axial direction of the motor unit. The electronic circuit includes semiconductor switching elements, which switch over coil currents in a stator of the motor unit. The coil currents are large and flow to the semiconductor switching elements. According to this drive apparatus, however, heat generated by the large currents is likely to be transferred to the motor unit because of integration of the motor unit and the electronic circuit. Since the motor unit is covered with a motor case, the heat stays in the motor unit and cannot be radiated or dissipated properly.

### SUMMARY

It is therefore an object to provide a drive apparatus, which has improved heat radiation performance.

According to one aspect, a drive apparatus includes a stator, a rotor provided radially inside the stator and rotatable relative to the stator, a shaft fixed to the rotor, a first bearing supporting one side of the shaft rotatably, a second bearing supporting an other side of the shaft rotatably, a first end frame provided at an end part of one axial side of the stator to hold the first bearing, a second end frame provided at an end part of an other axial side of the stator to hold the second bearing, and an electronic control unit provided at one axial end part of the shaft for controlling driving of the shaft. The stator has an outer wall surface, which is exposed between the first end frame and the second end frame.

### BRIEF DESCRIPTION OF THE DRAWINGS

The above and other objects, features and advantages will become more apparent from the following detailed description made with reference to the accompanying drawings. In the drawings:

FIG. 1 is a side view of a drive apparatus according to a first embodiment;

FIG. 2 is a schematic diagram of a power steering apparatus using the drive apparatus shown in FIG. 1;

FIG. 3 is a plan view of the drive apparatus taken in a direction III in FIG. 1;

FIG. 4 is a sectional view of the drive apparatus taken in a line IV-IV in FIG. 3;

FIG. 5 is a side view of a drive apparatus according to a second embodiment; and

FIG. 6 is a side view of a drive apparatus according to a third embodiment.

### EMBODIMENT

A drive apparatus will be described with reference to plural embodiments shown in the drawings, in which the same or similar components are designated by the same or similar reference numerals for simplification of description.

### First Embodiment

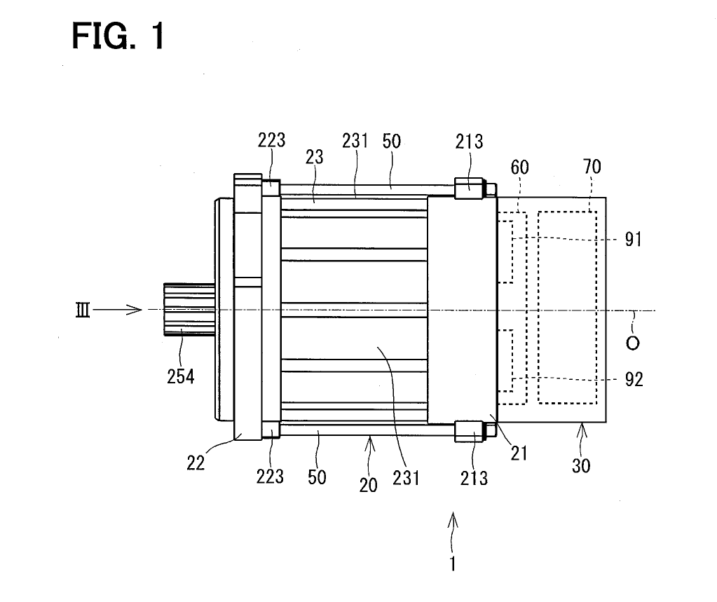

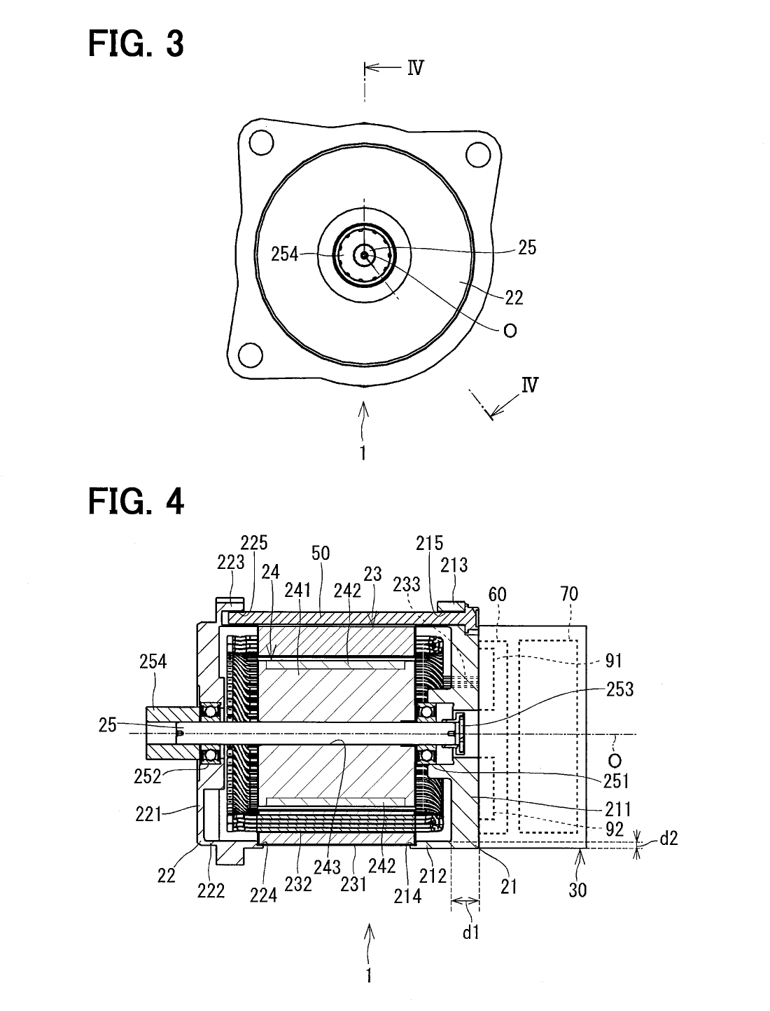

A drive apparatus according to a first embodiment is used in an electric power steering system (EPS) of a vehicle, which assists a driver's steering operation by an electric motor. This drive apparatus is shown in FIG. 1 to FIG. 4.

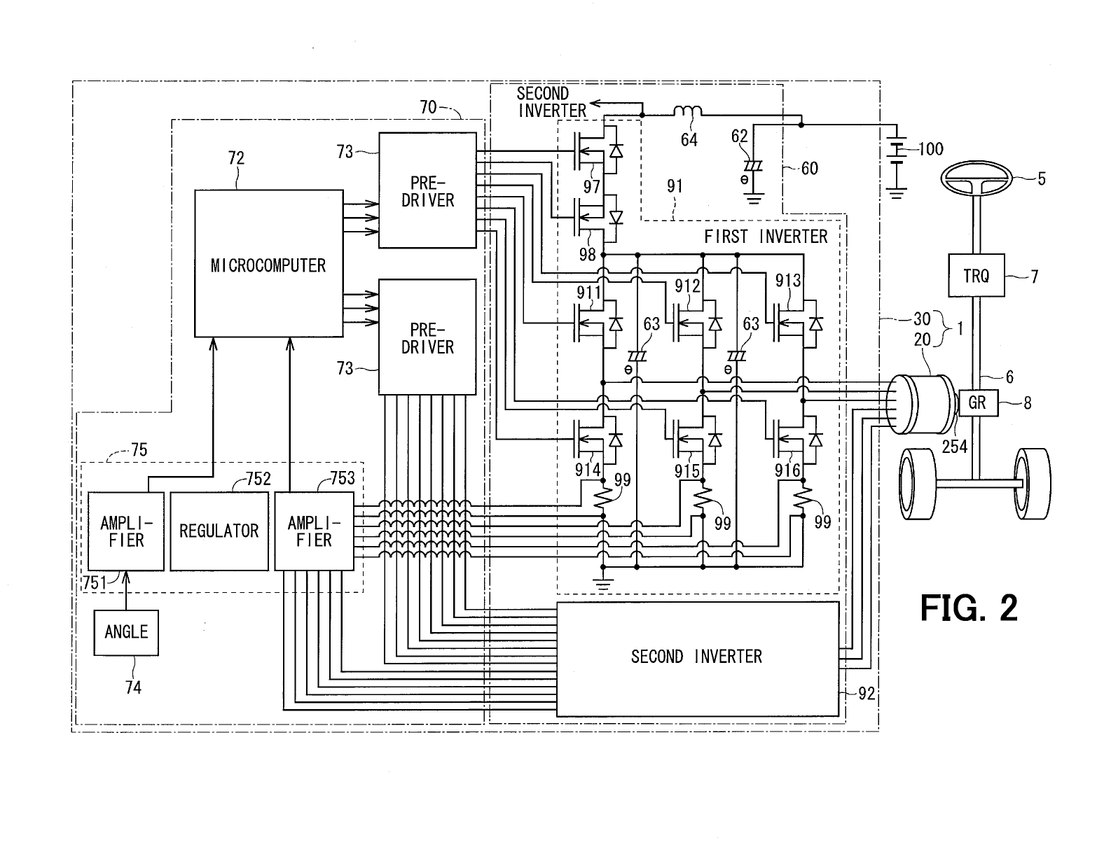

Referring first to FIG. 2, a drive apparatus 1 includes a motor unit 20 and an electronic control unit 30. The drive apparatus 1 is provided so that an output end 254 of the motor unit 20 is meshed with a gear 8 of a gear box provided on a column shaft 6 of a steering wheel 5. The drive apparatus 1 drives the motor unit 20 to rotate in both forward and reverse directions and generate assist power for assisting a steering operation based on a torque signal, a vehicle speed signal and the like. The torque signal is outputted from a torque sensor 7, which detects a steering torque of a steering wheel 5. The vehicle speed signal is acquired from a controller area network (CAN).

The control unit 30 is configured electrically as shown in FIG. 2. The control unit 30 is provided with a drive circuit 60 and a control circuit 70. The drive circuit 60 supplies large currents to the motor unit 20. The control circuit 70 controls the drive circuit 60. The drive circuit 60 includes a first smoothing capacitor 62, a choke coil 64 and two (first and second) inverter circuits 91, 92.

The first smoothing capacitor 62 and the choke coil 64 forms a filter circuit for reducing noises transferred from other devices, which share a power source (for example, DC battery) 100. The choke coil 64 is connected in series in a conductor between the power source 100 and power relays 97, 98.

A first inverter circuit 91 includes metal-oxide-semiconductor field-effect transistors (MOSFETS, referred to as FETS) 911 to 916, which are field-effect-transistors. Each FET 911 to 916 is turned on and off between its source and drain in accordance with a gate potential.

The drains of the FETS 911, 912, 913, which are at an upper arm side, that is, at a high potential side, are connected to a power source side. The sources of the FETS 911, 912, 913 are connected to the drains of the corresponding FETS 914, 915, 916, which are at a lower arm side, that is, at a low potential side. The sources of the FETS 914, 915, 916 are connected to the ground through respective shunt resistors 99. Junctions between the FETS 911, 912, 913 at the upper arm side and the FETS 914, 915, 916 at the lower arm side are connected to the motor unit 20 electrically. A second inverter circuit 92 has the same configuration as the inverter circuit 91.

The drive circuit 60 has the power relays 97 and 98 for the two sets of inverter circuits 91 and 92. The power relays 97 and 98 are formed of similar FETS 911 to 916. The power relays 97 and 98 are provided between the FETS 911 to 916 and the choke coil 64 and shut off currents from flowing to the motor unit 20 side through the FETS 911 to 916 upon occurrence of an abnormality.

The shunt resistors 99 are connected electrically between the FETS 914 to 916 and the ground. The current supplied to the motor is detected by a voltage or a current supplied to the shunt resistor 99.

Second smoothing capacitors 63 are connected between a conductor of a power source side of the FETS 911 to 913 and a conductor of the shunt resistors 99 at the ground sides. That is, the second smoothing capacitors 63 are connected to the FETS 911 to 916, respectively. The second smoothing capacitor 63 stores charge to assist power supply to the FETS 911 to 916 and absorb ripple currents generated at the time of switching of currents.

The control circuit 70 includes two pre-drivers 73, a customized integrated circuit (IC) 75, a rotation angle sensor 74 and a microcomputer 72. The customized IC 75 has, as functional blocks, a position sensor signal amplifier circuit 751, a regulator circuit 752 and a detection voltage amplifier circuit 753.

The regulator circuit 752 is a stabilizer circuit for stabilizing electric power. The regulator circuit 752 stabilizes the electric power supplied to various circuits. For example, the microcomputer 72 operates with a predetermined voltage (for example, 5V) stabilized by the regulator circuit 752.

A signal of the rotation angle sensor 74 is inputted to the position sensor signal amplifier circuit 751. The rotation angle position sensor 74 detects a rotation position signal of the motor unit 20 so that the detected rotational position signal is applied to the position sensor signal amplifier circuit 751. The position sensor signal amplifier circuit 751 amplifies the rotation position signal and applies the amplified signal to the microcomputer 72. The detection voltage amplifier circuit 753 detects terminal voltages developed at both ends of the shunt resistors 99, amplifies the terminal voltages and applies the amplified voltages to the microcomputer 72.

The microcomputer 72 receives the rotation position signal of the motor unit 20, the terminal voltages of the shunt resistors 99, the steering torque signal, the vehicle speed signal and the like. The microcomputer 72 controls the inverter circuit 91 through the pre-driver circuit 73 in response to the rotation position signal when these signals are inputted. Specifically, the microcomputer 72 controls the inverter circuit 91 by causing the pre-driver circuit 72 to change the gate voltages of the six FETS 911 to 916 so that the FETS 911 to 916 are switched to turn on and off.

The computer 72 further controls the inverter circuit 91 in accordance with the terminal voltages of the shunt resistors 99, which are inputted from the detection voltage amplifier circuit 753, so that the currents supplied to the motor unit 20 vary in a sine wave form. The microcomputer 72 controls the second inverter circuit 92 in the similar manner as it controls the first inverter circuit 91.

The drive apparatus 1 is configured mechanically as shown in FIGS. 1, 3 and 4. As shown in FIG. 1, the motor unit 20 and the control unit 30 are juxtaposed in a direction of a central axis O of a shaft 25. This central axis O of the shaft 25 is referred to as an axial direction. The central axis O is a rotation axis of the motor unit 20. A direction perpendicular to the axial direction is referred to as a radial direction. The control unit 30 side (left side) and the motor unit 20 side (right side) are referred to as one end side and the other end side in the axial direction.

As shown in FIG. 4, the motor unit 20 includes a first end frame 21, a second end frame 22, a stator 23, a rotor 24, a shaft 25, a first bearing 251 and a second bearing 252.

The first end frame 21 is formed of, for example, a metal such as aluminum or the like in a bottomed cylindrical shape. The first end frame 21 has a bottom wall 211, a side wall 212 and plural connection parts 213. The bottom wall 211 is formed to extend in the radial direction and is provided with the first bearing 251 at its radial center. The control unit 30 is attached to the bottom wall 211 of the first end frame 21.

The side wall 212 is formed in a cylindrical shape and extends from a radially outer periphery of the bottom wall 211 in the axial direction toward the other end side, that is, toward the second end frame 22. A cutout groove 214 is formed in a peripheral direction at the other end side of the side wall 212, that is, at the axially and radially inside part of the side wall 212. The cutout groove 214 is formed in an L shape in cross section take in the axial direction. The bottom wall 211 has a wall thickness d1 in the axial direction. This wall thickness d1 is determined to be thicker than a wall thickness d2 of the side wall 212 in the radial direction.

The connection part 213 is formed at plural locations on the radially outside periphery of the bottom wall 211 and the side wall 212. The connection part 213 has a through hole 215 formed in the axial direction. The second end frame 22 is formed of, for example, a metal such as iron or the like in a bottomed cylindrical shape. The second end frame 22 has a bottom wall 221, a side wall 222 and plural connection parts 223. The bottom wall 221 is formed to extend in the radial direction and is provided with the second bearing 252 at its radial center.

The side wall 222 is formed to extend from a radially outer periphery of the bottom wall 221 in the axial direction toward the one end side, that is, toward the first end frame 21. A cutout groove 224 is formed in a peripheral direction at the axially and radially inside part of the side wall 222. The cutout groove 214 also is formed in an L shape in cross section take in the axial direction.

The connection part 223 is formed at plural locations on the radially outside periphery of the bottom wall 221 and the side wall 222. The connection parts 223 face the connection parts 213 in the axial direction. The connection part has a thread hole 225 formed in the axial direction at a position corresponding to the connecting part 213 in the axial direction.

The stator 23 is provided between the first end frame 21 and the second end frame 22. One axial end and the other axial end of the stator 23 is fitted in the cutout groove 214 and the cutout groove 224, respectively. A thread 50 is inserted through each through hole 215 and thread-engaged with each thread hole 225 so that the stator 23 is tightly fixed between the first end frame 21 and the second end frame 22 in the axial direction by plural threads 50.

The stator 23 is formed in a cylindrical shape having an outer wall 231. A part of the outer wall 231 is exposed between the first end frame 21 and the second end frame 22. The stator 23 is formed by winding coils 232 about an iron core, which is formed of a stack of thin plates made of magnetic material. Motor terminal wires 233 taken out from the coils 232 are led toward the control unit 30 and connected to the inverter circuits 91 and 92 electrically.

The rotor 24 is provided radially inside the stator 23 to be rotatable relative to the stator 23. The rotor 24 is formed of, for example, magnetic material such as iron and in a cylindrical shape. The rotor 24 has a rotor core 241 and permanent magnets 242, which are provided on a radially outside surface of the rotor core 241. The permanent magnets 242 are arranged to provide an N-pole and an S-pole alternately in the peripheral direction of the rotor 24.

The shaft 25 is firmly fitted in an axial hole 243 formed in the center of the rotor core 241. One end and the other end of the shaft 25 are supported rotatably by the first bearing 251 and the second bearing 252, respectively. The shaft 25 is thus rotatable with the rotor 24 relative to the stator 23.

The shaft 25 has a magnet 253 at its one end, which is at the control unit 30 side. This magnet 253 is exposed to the control unit 30 side.

The shaft 25 has an output end 254 at an end part opposite to the control unit side 30. The output end 254 is coupled to the gear 8 and drives the column shaft 6 by rotation of the gear 8 (FIG. 2), when the shaft 25 is rotated.

The control unit 30 includes various electronic components forming the drive circuit 60 and various electronic components forming the control circuit 70. The inverter circuits 91 and 92 of the drive circuit 60 abut and contact the bottom wall 211 of the first end frame 21. The bottom wall 211 of the first end frame 21 functions as a heat sink.

As described above, a part of the outer wall 231 of the stator 23 is exposed between the first end frame 21 and the second end frame 22. In comparison to a case, in which the stator 23 is fully covered by the motor case, the stator 23 directly contacts the outside air thereby suppress heat of the motor unit 20 from being confined in the motor unit 20. It is thus possible to improve the heat radiation and dissipation performance of the drive apparatus 1.

In addition, the first end frame 21 is formed so that the wall thickness d1 of the bottom wall 211 in the axial direction is formed to be thicker than the wall thickness d2 of the side wall 212 in the radial direction. Since the thickness d2 of the side wall 212 in the radial direction is formed to be thinner, it is possible to suppress the heat generated by the control unit 30 from being transferred to the stator 23 through the sidle wall 212. It is also possible to suppress the heat generated by the currents flowing in the coils of the stator 23 from being transferred to the control unit 30 through the side wall 212. For this reason, the heat is suppressed from being transferred mutually between the motor unit 20 and the control unit 30.

Since the wall thickness d1 of the bottom wall 211 is formed to be thicker in the axial direction, it is possible to promote the transfer of heat generated by the control unit 30. It is thus possible to improve the heat radiation performance of the control unit 30 through the bottom wall 211.

The inverter circuits 91 and 92 are in contact with the bottom wall 211. Thus the heat generated by the inverter circuits 91 and 92 is readily transferred to the rotor 24 and the shaft 25 through the bottom wall 211. Thus the heat radiation and dissipation of the control unit 30 by the bottom wall 211 is improved.

### Second Embodiment

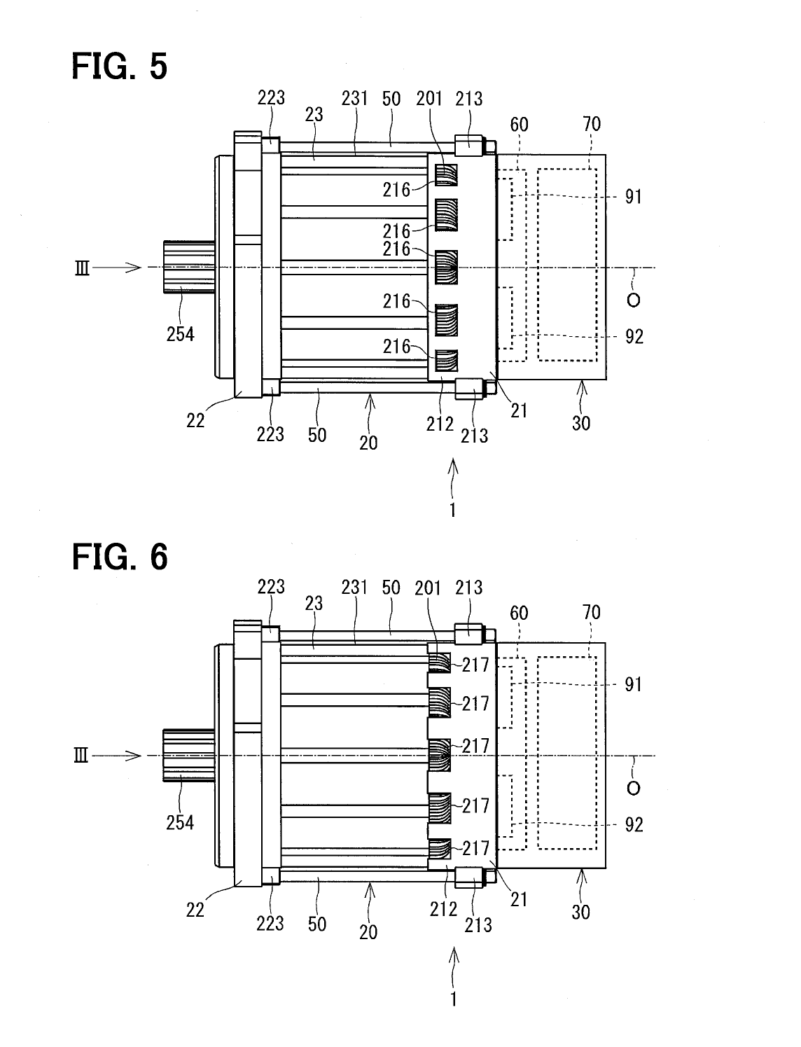

A drive apparatus according to a second embodiment is shown in FIG. 5. According to the second embodiment, rectangular holes 216 are provided at plural locations in the peripheral direction on the side wall 212 of the first end frame 21, to which the control unit 30 is attached. Each hole 216 penetrates the side wall 212 in the radial direction such that coils 201 of the motor unit 20 are exposed through the holes 216. Thus the heat radiation performance of the motor unit 20 is enhanced.

### Third Embodiment

A drive apparatus according to a third embodiment is shown in FIG. 6. According to the third embodiment, recesses 217 are formed at plural locations in the peripheral direction on the side wall 212. Each recess 217 is formed from an axial end of the other end side of the side wall 212 toward the one end side such that the coils 201 of the motor unit 20 are exposed. The axial end of the other end part of the side wall 212 is thus formed in a crank shape in the peripheral direction. As a result, the third embodiment provides the similar advantages as the second embodiment.

### Other Embodiment

In the above-described embodiments, the first end frame 21 and the second end frame 22 are formed separately. As the other embodiment, the first end frame 21 and the second end frame 22 may be formed integrally.

In the second embodiment, the rectangular holes 216 are formed at plural locations on the side wall 212. As the other embodiment, the holes 216 formed on the side wall 212 may be in a circular shape or a polygonal shape.

In the third embodiment, the side wall 212 is formed in the crank shape at the axially inside end, which is opposite to the axially outside end of the side wall 212. As the other embodiment, the side wall 212 may be formed in a sawthooth shape at the axially inside end of the side wall 212.

In the above-described embodiments, two sets of the inverter circuits 91 and 92 are used to drive the motor. As the other embodiment, one set or three or more sets of inverter circuits may be used to drive the motor.

In the above-described embodiments, the control unit 30 is provided at a position, which is opposite to the gear box of the motor. As the other embodiment, the control unit 30 may be provided between the motor and the gear box. In this example, the shaft 25 of the motor unit 20 passes through the control unit 30 and extends toward the gear box.

In the above-described embodiments, the drive apparatus 1 is used for the EPS of the vehicle. As the other embodiment, the drive apparatus 1 may be used for other fields.

What is claimed is:

1. A drive apparatus comprising:
a stator;
a rotor provided radially inside the stator and rotatable relative to the stator;
a shaft fixed to the rotor;
a first bearing supporting one side of the shaft rotatably;
a second bearing supporting an other side of the shaft rotatably;
a first end frame provided at an end part of one axial side of the stator to hold the first bearing;
a second end frame provided at an end part of an other axial side of the stator to hold the second bearing; and
an electronic control unit provided at one axial end part of the shaft for controlling driving of the shaft,
wherein the stator has an outer wall surface, which is exposed between the first end frame and the second end frame.

2. The drive apparatus according to claim 1, wherein:
the first end frame includes a bottom wall extending in a radial direction of the shaft and a side wall extending in an axially inside direction of the shaft form the bottom wall, the bottom wall having a wall thickness thicker than a wall thickness of the side wall.

3. The drive apparatus according to claim 1, wherein:
the electronic control unit includes an inverter circuit having plural semiconductor elements, the electronic control unit contacting the bottom wall of the first end frame in the axial direction of the shaft.

4. The drive apparatus according to claim 2, wherein:
the side wall includes plural through holes arranged in a peripheral direction of the shaft and passing the side wall in the radial direction of the shaft.

5. The drive apparatus according to claim 2, wherein:
the side wall includes plural recesses arranged in a peripheral direction of the shaft and being concave from an axially inside part of the side wall toward the bottom wall.

6. The drive apparatus according to claim 2, wherein:
the electronic control unit includes an inverter circuit having plural semiconductor elements, the electronic control unit contacting the bottom wall of the first end frame in the axial direction of the shaft.
